(19) United States
(12) Patent Application Publication
(10) Pub. No.: US 2013/0050679 A1
(43) Pub. Date: Feb. 28, 2013

(54) VALIDATION APPARATUS AND LIGHT SOURCE MODULE THEREOF

(71) Applicant: Shih-Pin WU, Taipei City (TW)

(72) Inventor: Shih-Pin WU, Taipei City (TW)

(73) Assignee: International Currency Technologies Corp.

(21) Appl. No.: 13/221,862

(22) Filed: Aug. 30, 2011

(51) Int. Cl. G06K 9/74; F21V 5/04

(52) U.S. Cl. 356/71; 362/235

(57) ABSTRACT

A light source module (13) mainly includes a plurality of light emitting units (132) and a lens array (133). The light emitting units (132) are arranged along a predetermined direction and respectively emit lights. The lens array (133) has a plurality of lens units (134) connected together along an axis (I) parallel to the predetermined direction. The lens units (134) each receive the lights emitted from the light emitting units (132). Each of the lens units (134) has a convex surface (135) intersecting with the light emitting direction of the light emitting units (132). The convex surface (135) is constituted by a first arc line (136) rotated with respect to the axis (I). The convex surface (135) also has a second arc line (137) perpendicularly intersecting with the first arc line (136). The radius of curvature of the first arc line (136) is longer than the radius of curvature of the second arc line (137). In addition, the present invention also provides a validation apparatus having the above-mentioned light source module (13).

### BACKGROUND OF THE INVENTION

1. Field of the Invention

The present invention relates to a validation apparatus, in particularly to a validation apparatus and light source module thereof used for automatic vending machine or automatic service machine.

2. Description of Related Art

Automatic vending machines or automatic service machines usually have validation apparatus for identifying user's valuable documents delivered into the automatic vending machines or the automatic service machines. Since plastic payment cards like credit cards are widely used in recent years, some automatic vending machines or automatic service machines can identify the plastic payment cards as well for avoiding credit card fraud.

For avoiding fraud, some security features are put on the credit cards or valuable documents. With these security features, credit cards or valuable documents can not be easily forged. However, the validation apparatus now used in the automatic vending machines do not have enough resolution to clearly identify those security features.

Conventional validation apparatus for identifying the valuable documents or plastic payment cards includes a light source module, which has a plurality of light emitting diodes arranged on a strip-shaped circuit board, and a lens array arranged over the strip-shaped circuit board.

The lens array has a plurality of lenses respectively facing the light emitting diodes. The lenses are used for converging the lights emitted from the light emitting diodes. Each of the lenses is a positive lens or a rod lens. Light emitted from each of the light emitting diodes is converged by the lens and then generates a circular shaped intensity distribution. The intensity distribution is symmetrical and has highest intensity in its center and gradually decreases outwardly. Besides, each light distribution generated by each of the light emitting diodes is partially overlapped with the adjacent light distribution from the adjacent light emitting diodes. However, the overall light intensity distribution generated by the light source module along its longitudinal direction is not a constant. Such a variation degrades the performance of identification.

In order to solve the above-mentioned problem, the conventional identifying device for identifying valuable documents or plastic payment cards has a lens for shaping light. The lens faces the light emitting diodes and shapes the light emitted from the light emitting diodes into a parallel light. However, in practical use, the resolution of the light delivering through the lens is seriously downgraded to 2 to 7 mm. Thus, the performance of the image identification of the identifying device is lowered and most of the security features on the valuable documents can not be clearly identified.

### SUMMARY OF THE INVENTION

The present invention is to provide a validation apparatus having a specially designed light source module, capable of providing a uniformly light intensity distribution for improving the image identifying performance of the validation apparatus.

The light source module includes a plurality of light emitting units and a lens array. The light emitting units are arranged along a predetermined direction and each emitting lights. The lens array includes a plurality of lens units connected together along an axis parallel to the predetermined direction. The lens units respectively receive the lights emitted from the light emitting units. Each of the lens units has a convex surface intersecting with the direction of the light emitted from each the light emitting units. The convex surface is constituted by a first arc line rotated with respect to the axis. The convex surface further has a second arc line perpendicularly intersecting with the first arc line. The radius of curvature of the first arc line is longer than the radius of curvature of the second arc line.

In addition, the present invention provides a validation apparatus including the above-mentioned light source module and a detecting module for detecting the lights emitted from the light emitting units delivering through the lens units.

### BRIEF DESCRIPTION OF THE DRAWINGS

FIG. 1 is an exploded view showing a validation apparatus of the present invention;

FIG. 2 is an exploded view showing a light source module of the present invention;

FIG. 3 is a schematic view showing a lens unit of the present invention;

FIG. 4 is another schematic view showing the lens unit of the present invention;

FIG. 5 is a schematic view showing the light source module of the present invention;

FIG. 6A is a chart of light intensity distribution of a strip-shaped beam;

FIG. 6B is an expanded view of FIG. 6A;

FIG. 7 is sectional view showing the validation apparatus of the present invention; and

FIG. 8 is a schematic view showing when a valuable document is inserted into the validation apparatus.

### DETAILED DESCRIPTION OF THE INVENTION

A detailed description of the present invention will be made with reference to the accompanying drawings.

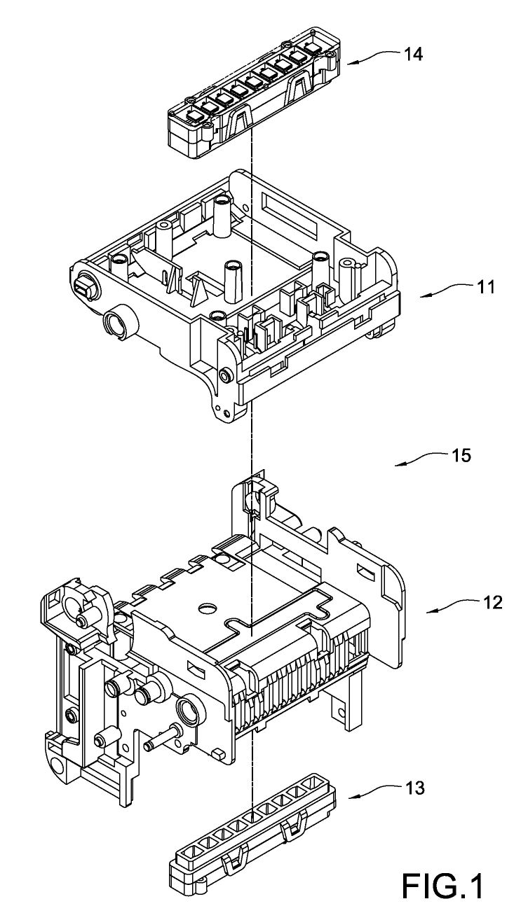

FIG. 1 shows a validation apparatus according to an embodiment of the present invention. The validation apparatus mainly includes an upper base 11, a lower base 12, a light source module 13 and a detecting module 14. A tunnel 15 is defined by the upper base 11 and the lower base 12 for delivering the valuable documents or the plastic payment cards like credit cards. The light source module 13 is embedded in the lower base 12 for emitting light into the tunnel 15. The detecting module 14 is embedded in the upper base 11 and correspondingly located over the light source module 13, for receiving the light emitted from the light source module 13.

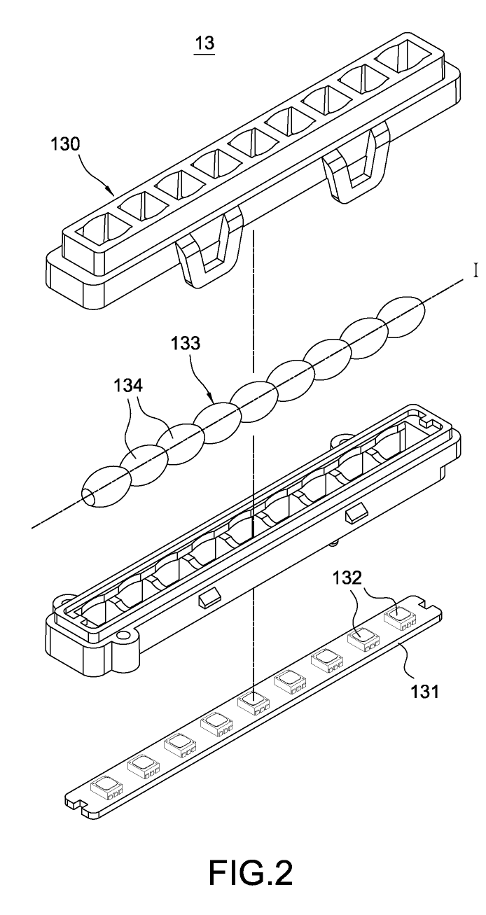

As FIG. 2 shows, the light source module 13 includes a housing 130, a circuit board 131, a plurality of light emitting units 132 and a lens array 133. The lens array 133 is installed inside the housing 130. The light emitting units 132 are arranged along a predetermined direction on the circuit board 131 and electrically connected to the circuit board 131. Each of the light emitting units 132 is used for emitting light. More specifically, the light emitting units 132 are light emitting diodes. In practical use, the light emitting units 132 can also be light bulbs, light tubes or laser diodes. A plurality of holes are formed respectively on the upper side and the lower side of the housing 130 for delivering the lights emitted from the light emitting units 132. Lights emitted from the light emitting units 132 can pass through those holes and reach the lens array 133 inside the housing 130. The lens array 133 has a plurality of lens units 134 connected together along an axis (I) parallel to the predetermined direction. Each of the lens units 134 is used for receiving the light emitted from the corresponding light emitting unit 132. In practical manufacturing, the lens units 134 of the lens array 133 are one-piece formed by injection molding. In this embodiment, the number of the lens units 134 of the lens array 133 is nine, but not limited in practical use.

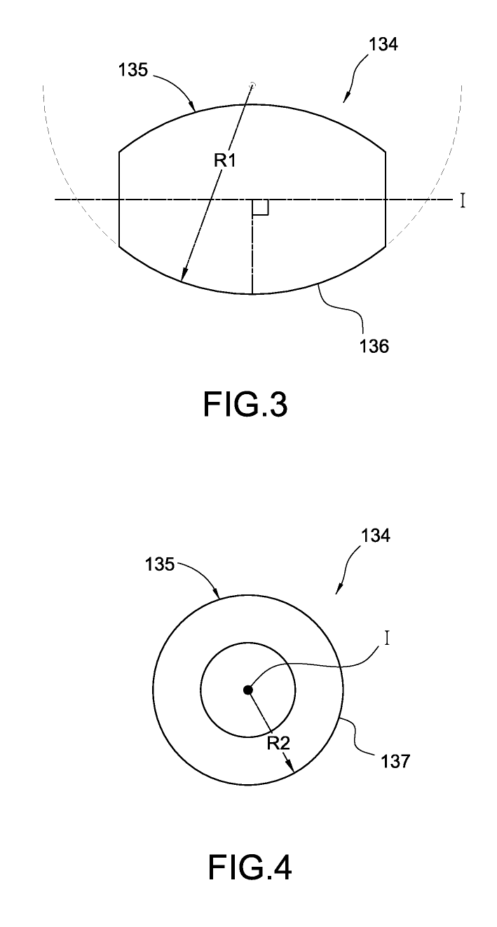

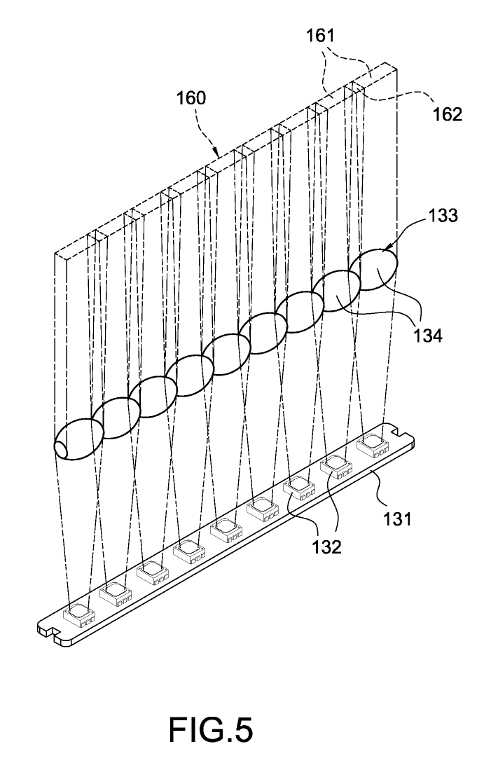

As FIG. 3 shows, each of the lens units 134 has a convex surface 135. The convex surface 135 is constituted by a first arc line 136 completely rotated with respect to the axis I. The first arc line 136 is coplanar with the axis I. As FIGS. 3 & 4 show, the convex surface 135 also has a second arc line 137 perpendicularly intersecting with the first arc line 136. The radius of curvature R1 of the first arc line 136 is longer than the radius of curvature R2 of the second arc line 137. More specifically, the radius of curvature R1 is within a range between 2.5 mm and 20 mm. The radius of curvature R2 is within a range between 0.5 mm and 5 mm.

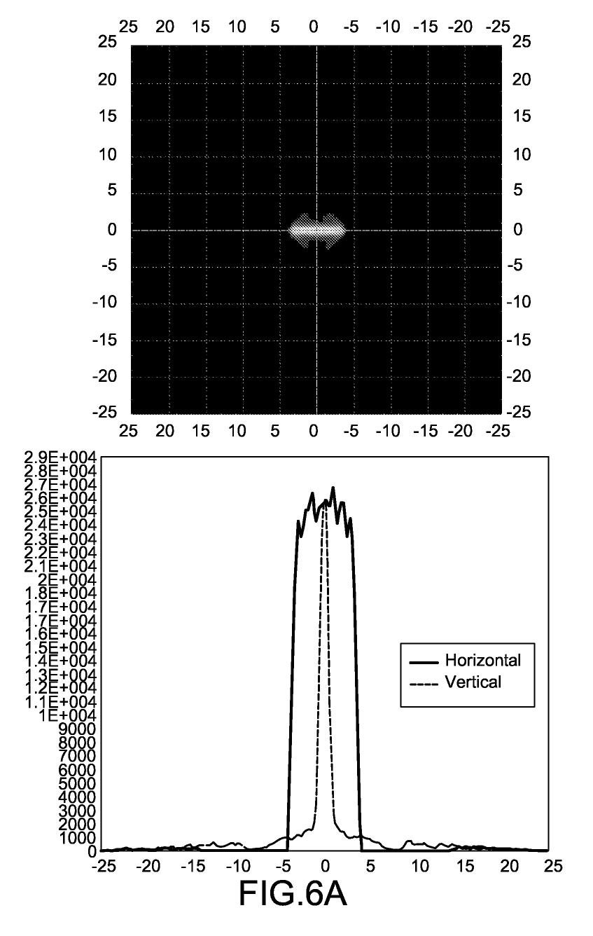

As FIG. 5 shows, the original distribution of light emitted form each of the light emitting units 132 is of circular shape. After the lens units 134, the light is beam-shaped into a strip-shaped beam 161. The width of the strip-shaped beam 161 is smaller than the radius of the original distribution of the light emitted form each of the light emitting units 132. The light intensity within each of the strip-shaped beam 161 is substantially uniform. Each of the strip-shaped beams 161 is overlapped by the adjacent strip-shaped beam 161. Thus, an overlapped portion 162 is formed between two adjacent strip-shaped beams 161. In ideal situation, the two adjacent strip-shaped beams 161 are just connected without any overlapping. All the strip-shaped beams 161 are connected forming a long-striped scanning light beam 160.

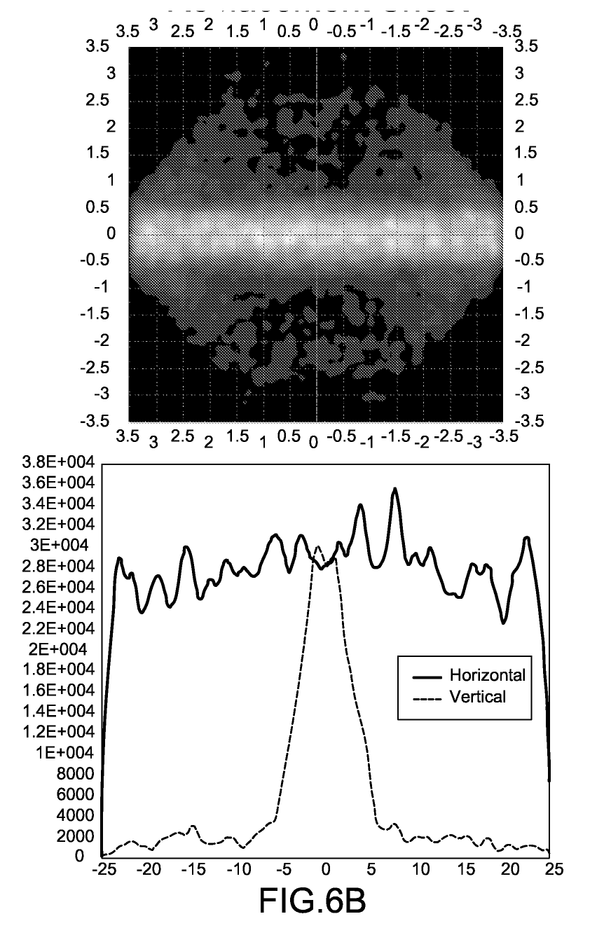

FIG. 6A and FIG. 6B are a light intensity distribution chart and a partially expanded view thereof, respectively. The solid line represents the light intensity distribution along the longitudinal direction of the strip-shaped beam 161. The dash line represents the light intensity distribution along the transverse direction of the strip-shaped beam 161. As can be seen in FIG. 6A and FIG. 6B, the light intensity distributions along the longitudinal and the transverse directions of the strip-shaped beam 161 are both substantially uniform.

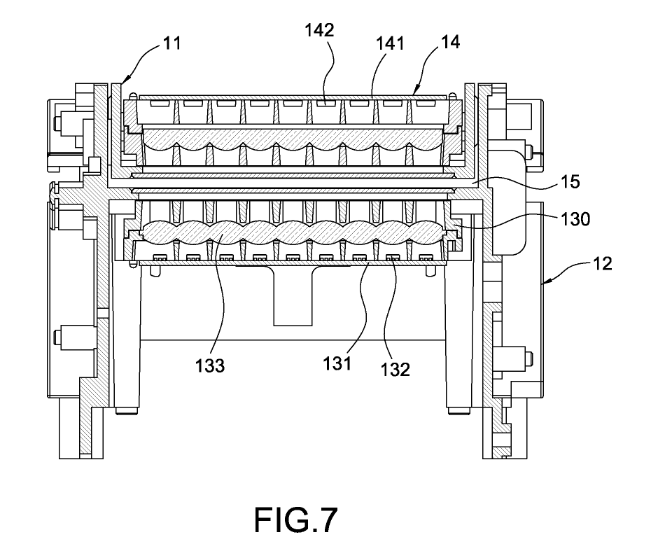

As FIG. 7 shows, the detecting module 14 is arranged above the tunnel 15 for receiving the scanning light beam 160, which is emitted from light emitting units 132 and passes through the lens units 133 and the tunnel 15. More specifically, the detecting module 14 includes a circuit board 141 and a plurality of detecting devices 142. The detecting devices 142 are arranged on the circuit board 141 and electrically connected to the circuit board 141. The detecting devices 142 can be photo diodes, photo transistors, charge-coupled devices (CCD) or complementary metal-oxide semiconductor (CMOS) sensor.

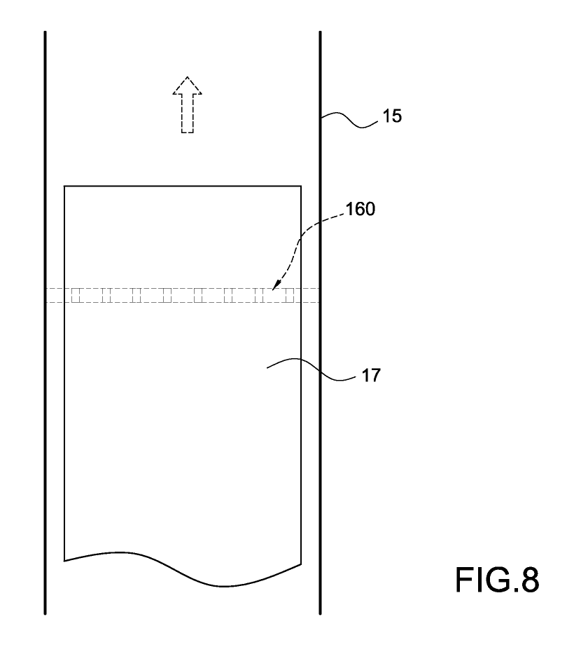

As FIG. 7 and FIG. 8 show, in practical use, when a valuable document 17 is inserted into the tunnel 15, the scanning light beam 160 emitted from the light source module 13 will illuminate the valuable document 17. The direction of the scanning light beam 17 is perpendicular to the moving direction of the valuable document 17. The scanning light beam 160 is then received by the detecting module 14. The signal modulation to the scanning light beam 160 can be intensity modulation, polarization modulation, wavelength modulation and propagating direction modulation. In conclusion, the validation apparatus can obtain clear image of the valuable documents or the plastic payment cards for further validation process. Thus, the security features on the valuable documents can be clearly identified to avoid frauds.

Since the width of the strip-shaped beam 161 is smaller than the radius of the original distribution of the light emitted from the light emitting units 132, the image resolution performance of the validation apparatus is improved along the moving direction of the valuable documents. Since the light intensity of the strip-shaped beam 161 is substantially uniform along its longitudinal direction, the resolution of the image captured by the detecting module 14 is improved. The positional tolerance of the valuable documents along a direction perpendicular to its moving direction in the tunnel 15 can be broadened and the signal-to-noise ratio can be increased.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A light source module comprising:
a plurality of light emitting units (132) arranged along a predetermined direction and each emitting lights; and
a lens array (133) comprising a plurality of lens units (134) connected together along an axis (I) parallel to the predetermined direction, the lens units (134) respectively receiving the lights emitted from the light emitting units (132), each of the lens units (134) comprising a convex surface (135) intersecting with the direction of the light emitted from each the light emitting units (132), the convex surface (135) being constituted by a first arc line (136) rotated with respect to the axis (I),
wherein the convex surface (135) further comprising a second arc line (137) orthogonal to the first arc line (136), and the radius of curvature of the first arc line (136) is longer than the radius of curvature of the second arc line (137).

2. The light source module as claim 1, wherein the convex surface (135) is constituted by a first arc line (136) completely rotated with respect to the axis (I), and the convex surface (135) is a closed surface.

3. The light source module as claim 1, wherein the lens units (134) of the lens array (133) are of one pieced form.

4. The light source module as claim 1, further comprising a circuit board (131) for arranging the light emitting units (132) and electrically connecting the light emitting units (132).

5. A validation apparatus, comprising:
a light source module (13) comprising a plurality of light emitting units (132) and a lens array (133), the light emitting units (132) being arranged along a predetermined direction and emitting lights respectively, the lens array (133) comprising a plurality of lens units (134) connected together along an axis (I) parallel to the predetermined direction, the lens units (134) respectively receiving the lights emitted from the light emitting units (132), each of the lens units (134) comprising a convex surface (135) intersecting with the light emitting direction of each of the light emitting units (132), the convex surface (135) being constituted by a first arc line (136) rotated with respect to the axis (I), wherein the convex surface (135) further comprising a second arc line (137) orthogonal to the first arc line (136), the radius of curvature of the first arc line (136) being longer than the radius of curvature of the second arc line (137),
a detecting module for detecting the lights emitted from the light emitting units (132) delivering through the lens units (134).

6. The validation apparatus as claim 5, wherein the convex surface (135) is constituted by the first arc line (136) completely rotated with respect to the axis (I) and is a closed surface.

7. The validation apparatus as claim 5, wherein the lens units (134) of the lens array (133) are of one pieced form.

8. The validation apparatus as claim 5, wherein the light source module (13) further comprises a circuit board (131) for arranging the light emitting units (132) and electrically connecting the light emitting units (132).
